(19) United States
(12) Patent Application Publication
(10) Pub. No.: US 2013/0167226 A1
(43) Pub. Date: Jun. 27, 2013

(54) Handheld Mobile Device with USB Hard Drive and Optional Biometric Scanner, and Systems Including the Same

(71) Applicant: Woodrow LIN, New York, NY (US)

(72) Inventor: Woodrow LIN, New York, NY (US)

(21) Appl. No.: 13/728,998

(22) Filed: Dec. 27, 2012

Related U.S. Application Data
(60) Provisional application No. 61/580,556, filed on Dec. 27, 2011.
(60) Provisional application No. 61/694,215, filed on Aug. 28, 2012.

(51) Int. Cl. H04M 1/02; G06F 21/32; G06F 13/36

(52) U.S. Cl. CPC H04M 1/0256; G06F 13/36; G06F 21/32
USPC 726/19; 455/556.1; 710/305

(57) ABSTRACT

Mobile handheld communication devices such as cellular and/or smart phones are equipped with a detachable USB drive, and optionally, a biometric scanner and/or an electronic release mechanism and/or circuitry. The communication device has a housing, a central processing unit (CPU) within the housing, a memory controller within the housing and coupled to the CPU, and a universal serial bus (USB) hard drive that electrically communicates with the memory controller. The USB hard drive has an outer surface or casing that is integrated and/or integratable with the housing. The USB device may include a USB interface, a hard drive that communicates through the USB interface, and a biometric sensor. The biometric sensor establishes or authorizes electronic communication between the hard drive and the USB interface when biometric data obtained with the biometric sensor matches data stored in the hard drive.

### RELATED APPLICATIONS

This application claims priority to U.S. Provisional Patent Application Nos. 61/580,556, filed Dec. 27, 2011 (Attorney Docket No. ET-001-PR), and 61/694,215, filed Aug. 28, 2012 (Attorney Docket No. ET-001-PR2), each of which is incorporated herein by reference in its entirety.

### FIELD OF THE INVENTION

The present invention generally relates to the field of cellular telephones and other wireless two-way audio devices. More specifically, embodiments of the present invention pertain to cellular telephones and other mobile handheld communication devices equipped with a detachable USB drive, and optionally, a biometric scanner, and/or an electronic release mechanism and/or circuitry, and networks and systems utilizing the same.

### DISCUSSION OF THE BACKGROUND

Generally, today's USB devices are compatible with the USB 2.0 standard or older, slower forms of USB. As shown in FIG. 1, which shows the wiring schematic 10 for the normal situation with a regular USB cable, this standard generally uses four lines 11, 13, 15, 17 plus a shield (ground) in the cables and connectors. Newer standard connector types include micro-USB and mini-USB. They use five lines. The extra line is an ID line, which tells the system whether the device is a host or a peripheral. In normal operations with four-line USB connectors, it is assumed that the computer (e.g., PC) is the host, and the attached device (e.g., a camera, a printer, a mouse, keyboard, hard drive, or USB flash drive) is a peripheral device. With the implementation of the newer USB OTG (On The Go) specifications, it became possible to change the role of a USB device from peripheral to host by tying Pin4 18c (FIG. 2) of the micro-USB (or later the mini-USB type A or B) connector to ground or to Pin5 19 (FIG. 2B), which is connected to ground. Normally, in a peripheral device, Pin4 18c of the micro-USB or mini-B USB connector is left floating (see node 25 in FIG. 2A), which results in its being tied high by a resistor in the host device.

FIG. 2A shows the wiring schematic 10′ for the typical cellular phone micro-USB to USB connection, where the standard USB connector is attached to a computer (e.g., PC), which is the host, and the cellular phone is the peripheral. As one can clearly see, nothing is tied to Pin4 18c of the micro-USB connector on the cellular phone, because it is generally meant to be a peripheral, while the PC is meant to be the host.

FIG. 2B shows the cable wiring that allows a device with USB OTG capabilities to operate as a host device. If one connects the cable with Pin4 18c and Pin5 19 connected to each other, thus grounding Pin4 18c, the PC will not be damaged, and the cellular phone can still be charged with this connection. However, the cellular phone and the PC will not be able to communicate because they are both configured as hosts.

The USB OTG specification does have provisions for allowing a device to be either a host or a peripheral, depending on the negotiated protocol or the type of connector cable to which it is connected (e.g., mini-A or mini-B). Dual role devices use a mini-AB receptacle and accept either a mini-B or mini-A cable. Also, the USB OTG specification refers to a new type of connector called a USB mini-A, USB mini-B, or USB mini-AB. The mini-B is like a normal micro-USB cable in that Pin4 18b (FIG. 2A) is not connected to anything, and thus the device is meant to be used as a peripheral. The mini-A cable (FIG. 2B) has Pin4 18c tied to ground (Pin5 19). Thus, devices configured with a USB mini-A port are meant to be host devices.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Embodiments of the present invention relate to a mobile handheld communication device (e.g., a mobile and/or smart phone) which has a detachable universal serial bus (USB) drive (e.g., a USB flash drive or any similar drive) housed in the back of the phone or optionally on the perimeter of the phone. As a security feature, the USB drive can be detached from the phone via use of biometrics (e.g., a thumb print, voice recognition, retinal scanning, etc.). The USB connect portion of the drive inserts into the smart phone, creating a connection between the phone and USB drive. This type of apparatus leads to a secure system. Also, it allows a smart phone to be able to take on tasks that only computers such as laptop computers, desktop computers, workstations, etc., can do at this time.

In most embodiments, the present handheld communication device further comprises wireless communications circuitry within the housing, the wireless communications circuitry configured to wirelessly communicate with an external communications network. In various embodiments, the wireless communications circuitry is selected from the group consisting of a GPS circuit, a Wi-Fi circuit, a mobile broadband circuit, and a Bluetooth modem. In other or further embodiments, the wireless communication interface circuitry is in communication with interconnect circuitry in the communication device. The wireless communication interface circuitry may be configured to send and/or receive data to and/or from a wireless network, and may be selected from the group consisting of a serial peripheral interface (SPI), a universal asynchronous receiver/transmitter (UART), and a general purpose input/output (GPIO).

The biometric sensor may comprise a swipe-type, roller-pin, or fingerprint sensor, may be coupled to the memory controller and/or may further comprise voice recognition technology. In some embodiments, the biometric sensor enables, activates, and/or deactivates a lockpin configured to secure the USB hard drive within the housing. In some embodiments, the USB device includes the biometric sensor, which is coupled to a memory controller in electrical communication with the USB hard drive. The memory controller may be in communication with secure digital input output (SDIO) circuitry and be configured to transfer data to and/or from the hard drive using the SDIO circuitry.

In further embodiments, the handheld communication device further comprises a multimedia card. A first memory controller may be on the multimedia card, and the multimedia card further may comprise secure digital input output (SDIO) circuitry and/or be embedded. In even further embodiments, the present handheld communication device further comprises interconnect circuitry configured to provide data from circuitry in or external to the handheld communication device to the first CPU, direct memory access circuitry in communication with the interconnect circuitry and the CPU, audio circuitry in communication with the interconnect circuitry and configured to provide audio data to and receive audio data from the first CPU, a second memory controller and optional third memory controller in communication with the interconnect circuitry, configured to control access to data stored in a random access memory (RAM) and/or in a flash memory, and/or a mobile industry processor interface (MIPI) in communication with the interconnect circuitry, the MIPI configured to send data from a graphical processing unit (GPU) to a video display.

In other and/or further embodiments, the present handheld communication device further comprises a video interface in communication with the interconnect circuitry, the video interface being configured to provide data from the interconnect circuitry to a video display. The video interface may comprise a mobile industry processor interface (MIPI) or a high-definition multimedia interface (HDMI). The present handheld communication device may further comprise video codec hardware and/or software in communication with the interconnect circuitry, the video codec configured to enable video compression and/or decompression of a digital video signal provided to the interconnect circuitry.

The GPU in the present handheld communication device may further comprise a media instruction set configured to provide standardized acceleration for media and signal processing applications. The present handheld communication device may also further comprise cache memory in communication with the interface circuitry, configured to store copies of data stored in a flash memory or SDRAM, and/or a boot ROM configured to store an initial set of operations performed by the first CPU.

The present handheld communication device may further comprise one or more timers. The timer(s) may be in communication with the interface circuitry, and provide one or more timing signals to other circuits or circuitry, blocks, and/or domains in communication with the interface circuitry. The present handheld communication device may also further comprise an interrupt controller configured to allow data communication between the USB hard drive and the first CPU, and/or a trace and debug port, the trace and debug port configured to allow communication between an external testing and/or troubleshooting device and trace and debug circuitry in the handheld communication device. In some embodiments, the present handheld communication device may further comprise a service identity module (SIM) port, the SIM port configured to allow communication between a universal service identity module (USIM) and the first CPU in the handheld communication device. The USIM may further comprise a second CPU, configured to provide data stored on the USIM to the first CPU.

The present handheld communication device may further comprise a touch screen. The touch screen may further comprises a touch screen controller, configured to transmit and/or receive signals to and/or from the touch screen, and the touch screen controller may comprises a third CPU, configured to determine and/or detect the presence and location of a touch within the display area of the touch screen and provide data corresponding to the touch location to the first CPU. The touch screen controller may further comprise power management logic and/or circuitry configured to control a power supplied from a power source to the touch screen.

It is contemplated that concepts disclosed herein as applicable to memory drives having USB connectors are also applicable to other solid state drives and memories and other devices equipped or configured with an external serial advanced technology attachment (E-SATA) interface. These and other advantages of the present invention will become readily apparent from the detailed description of various embodiments below.

### BRIEF DESCRIPTION OF THE DRAWINGS

FIG. 1 shows a wiring schematic for a conventional USB interface.

FIG. 2A shows a wiring schematic for a conventional mini-B or micro-B USB to USB interface, and FIG. 2B shows a wiring schematic for a conventional mini-A or micro-A USB to USB interface.

FIGS. 3A-3D show various embodiments of ARM-based architectures for mobile (e.g., “smart”) phones incorporating a USB drive, a USB OTG port and/or drive, or a combination thereof.

FIGS. 4A-4D show various embodiments of ARM-based architectures for mobile (e.g., “smart”) phones incorporating a USB drive, a USB OTG port and/or drive, or a combination thereof, equipped with biosensor-based security devices.

FIGS. 5A-5D show further embodiments of ARM-based architectures for mobile/smart phones incorporating a USB drive, a USB OTG port and/or drive, or a combination thereof, equipped with biosensor-based security devices.

FIGS. 6A-6F show an embodiment of a mobile/smart phone incorporating various USB drives and an optional USB OTG port (e.g., for recharging the phone).

FIGS. 7A-7D show an embodiment of a mobile/smart phone incorporating a USB drive, equipped with various biosensor-based security devices.

FIGS. 8A-8B show exemplary pinouts and/or interfaces between the smart phones of FIGS. 6A and 7A and the exemplary USB drives of FIGS. 6A, 6D, 7A and 7C-7D.

FIGS. 9A-9B show further embodiments of mobile/smart phones incorporating a port for a USB drive and (in FIG. 9B) an optional USB OTG port.

FIG. 9C shows an exemplary USB drive for the mobile/smart phones of FIGS. 9A-9B.

FIG. 10 shows an exemplary wiring schematic for a mini- or micro-USB to USB interface including a switch.

FIG. 11 shows an exemplary ejector mechanism for the mini- or micro-USB to USB interface of FIG. 10.

### DETAILED DESCRIPTION

Reference will now be made in detail to various embodiments of the invention. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention. The invention, in its various aspects, will be explained in greater detail below with regard to exemplary embodiments.

Embodiments and purposes of this invention include:
Enabling the smart phone/USB port-hard drive combination to function as a security/storage/licensing drive
The USB hard drive serving as extra ram for the phone
The USB port/connection creates a physical firewall, thereby protecting personal files from hackers
The USB hard drive extending the phones' storage capability
The USB hard drive enhancing some or all of the phone's capabilities (e.g., by storing software programs, memory-intensive content such as games or movies, etc.)

Once the USB drive is removed from the phone, it can function with any computer equipped with one or more USB ports.

In general, the casing of the USB device fits into the phone. Possible design approaches include:
The USB drive may be encased within the housing of the phone. It may be covered with a slidable housing member, and slide out horizontally or vertically, depending on the orientation of the slidable housing member. In such embodiments, the device is unitary, comprising a smartphone with a detachable USB-type drive encased therein.
The USB drive may take up the entire bottom ⅝″-1″ of the phone. Alternatively, the USB drive may be inserted into a port or slot in the side or bottom of the phone and be ejected from the port or slot using a button adjacent to the port or slot.
The USB drive can slide out of the back of the phone, detaching just as if pulling out the battery.

Unlike attaching a USB drive to the external housing of the phone (similar to a personal computer), in preferred embodiments, the USB drive is situated internally (i.e., inside the housing of the phone) and is sealed tight (and optionally, is water tight and/or water-resistant). Once detached from the phone, the USB drive acts like a normal USB drive, but with added features. When attached to the phone, the USB drive acts as a memory, with additional support and security.

The smart phone/USB hard drive can also include enhancements for Bluetooth, Wi-Fi, and in mobile communications network connectivity. This enables mobile networking through USB drives, a common trend in present wireless-capable networking systems.

This invention also allows a system where there is only a terminal (instead of computers), and terminals download components from data housing and/or storage devices (e.g., a server, RAID array, etc.), cloud computing mainframe(s) or facility(ies), etc. Users access workspaces through the terminal (i.e., smart phone) via their USB drive, which is configured to hold licensing authorizations from any program needed to be used at the terminal. All storage and session history remains on the USB drive, and not on the terminal. This allows for a completely safe, private, and virus free computing and/or networking system.

Naturally, the smart phone must have dimensions (e.g., a thickness, width and length) sufficient to accommodate an internal (e.g., female) USB port. Optionally, the smart phone may be equipped with a mini- or micro-USB port (smaller than a standard USB port), configured to accommodate a USB flash drive. Because the USB flash drive can store programs and content, on-board memory requirements may be reduced in the phone to make space available for both the mini-/micro-USB port and the internal standard USB (e.g., USB 2.0, USB 3.0, etc.) port controller. Also, one may make intelligent trade-offs in existing phones keep required functionality in the existing or slightly expanded space of the smart phone, and/or give up certain optional functionality to make space available for the USB port and controller. With recent progress in smart phone battery technology, sufficient power can be provided to the (mini-/micro-)USB receiving (female) port to operate (mini-/micro-)USB peripheral devices such as a flash drive. Although not required, relatively sophisticated power management programs and/or hardware can be useful, particularly for write operations to the (mini-/micro-)USB flash drive. Alternatively, a battery may be included on the USB memory to provide power (or additional power) for read, write and erase operations.

A First Exemplary Mobile Device and Applications Processor

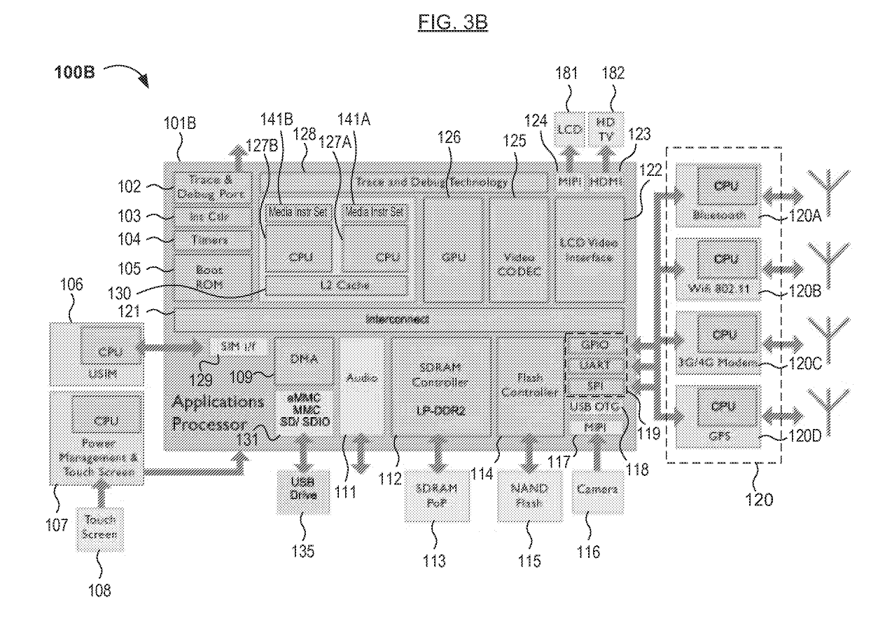

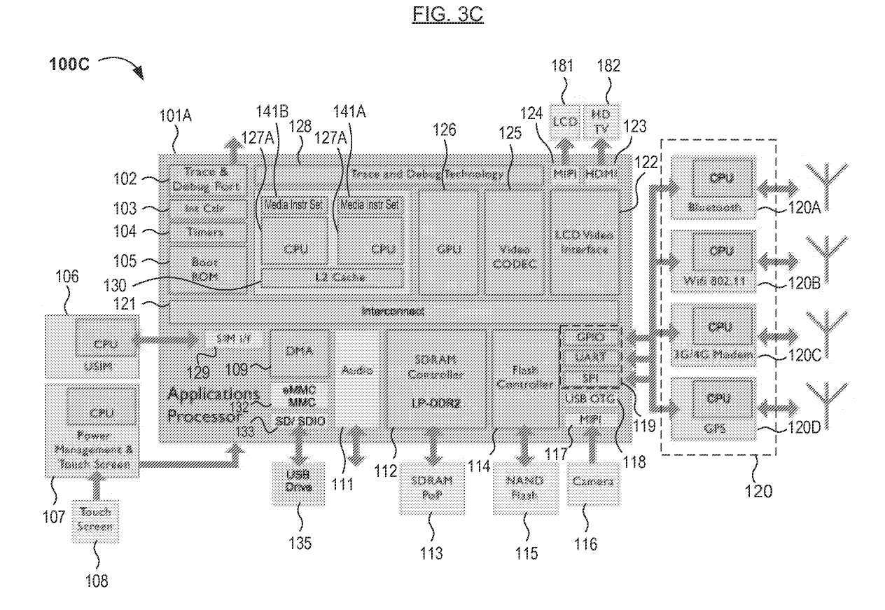

FIG. 3A shows a first exemplary block diagram including an advanced RISC machine (ARM) architecture or applications processor 101A for use in a handheld mobile device (e.g., a smartphone) 100A according to the present invention. Although an ARM applications processor is disclosed in the exemplary embodiments, the present invention is compatible with other handheld communication device processors and/or architectures.

As shown, the applications processor 101A sends and receives electronic signals from a universal service identity module (USIM) 106 that may further contain a SIM card (to allow mobile access to an authorized network), SIM interface circuitry 129, a touch screen 108 (e.g., via a power management and touch screen controller 107), and a USB drive 135. The USB drive (e.g., a flash drive) 135 may be a mini or micro USB drive that can be coupled to an appropriate USB port in the handheld mobile device (see FIGS. 3A-3B and the discussion thereof).

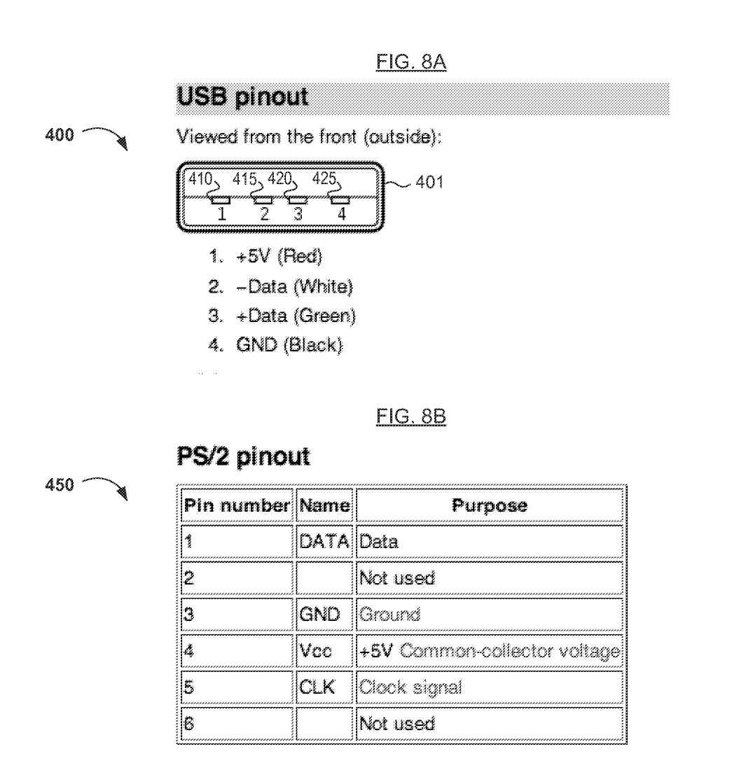

As discussed above, USB drive 135 is in communication with a secure digital (SD) multimedia card (MMC) 110, which may be embedded (e.g., an eMMC). The SD eMMC/MMC 110 comprises memory (e.g., one or more buffers and/or non-volatile data storage devices), and/or a memory controller (not shown) for the USB drive 135. SD eMMC/MMC 110 may have one or more on-board interfaces (not shown) with the USB drive and/or other components of the applications processor 101A (e.g., DMA controller 109). For example, the USB drive interface may comprise an internal female USB connector (e.g., as shown below with respect to FIG. 8A), an internal or external female micro USB connector, or any other interface capable of coupling the USB drive 135 to the architecture 101A in the handheld mobile device. In alternative embodiments, USB drive 135 or a flash memory drive can replace SD eMMC/MMC 110.

Additionally, a direct memory access (DMA) block 109 allows one or more hardware subsystems within the applications processor 101A to access system memory (e.g., USB drive 135) independently of the central processing units (CPUs) 127A and 127B. The applications processor 101A is configured to communicate with (i) a synchronous dynamic random access memory (SDRAM; e.g., a low power [LP] double data rate [e.g., DDR2] SDRAM) 113 via SDRAM controller 112 using a conventional post office protocol (PoP), and (ii) a NAND flash memory 115 via a flash controller 114. In some embodiments, the applications processor 101A can transfer signals to and from a camera 116, and to and/or from an audio source (e.g., headphones, speakers, a microphone, etc.) via audio block 111 in the applications processor 101A. For example, the camera 116 can provide data to a mobile industry processor interface (MIPI) 117 configured to receive data from or provide data to the camera 116.

Applications processor 101A may also include USB on-the-go (OTG) circuitry and/or a USB OTG port 118 to allow the handheld mobile device to act as a host and allow other circuitry (e.g., an external mouse, external keyboard, etc.) to be attached to the handheld mobile device. In some embodiments, the OTG circuitry and/or USB OTG port 118 allow the mobile device to electrically connect to a power supply and charge its battery (not shown). The applications processor 101A may further include external communications circuitry 119, including a serial peripheral interface (SPI) bus, a universal asynchronous receiver/transmitter (UART), and a general purpose input/output (GPIO) port, to facilitate communications with wireless function blocks 120.

A LCD video interface 122 is in communication with a video codec 125 and a graphics processing unit (GPU) 126 via interconnect 121. Alternatively, the applications processor 101A can provide video signals to external devices (e.g., a liquid crystal display [LCD 181], light-emitting diode [LED] display, an organic light-emitting diode [OLED] display, a plasma display, etc.) using video interface circuitry similar in function to LCD video interface 122. For example, a mobile industry processor interface (MIPI) port 124 can be used to provide a video signal to an LCD display 181, and a high-definition multimedia interface (HDMI) port 123 can provide a video signal to an HDTV (or analog) display 182.

Interconnect circuitry 121 within the applications processor 101A can transfer data from various sources to various destinations (e.g., external communications circuitry 119, the touch screen 108, camera 116 [through MIPI 117], USB drive 135 [through SD eMMC/MMC 110 and DMA controller 109], etc.). For example, cache 130 can provide the data received from interconnect 121 to one or more CPUs (e.g., CPU 127A or 127B) within the applications processor 101A for processing. The applications processor 101A may also include an instruction set (that may be stored in boot ROM 105 or NAND flash memory 115) that provides standardized acceleration for media and signal processing applications.

A trace and debug port 102, in conjunction with trace and debug technology (e.g., circuitry) 128, can be used to troubleshoot issues in applications processor 101A and/or associated hardware and/or software. Applications processor 101A also includes an interrupt controller 103, one or more timers 104, and boot read only memory (ROM) 105.

The applications processor 101A also comprises wireless communications circuitry 120. As shown, wireless communications circuitry 120 comprises Bluetooth circuitry 201A, WiFi circuitry (e.g., compatible with one or more 802.11 standards) 201B, a modem (e.g., a 3G or 4G modem) 202C, and GPS circuitry 202D.

The USB drive enables the amount of data stored on the handheld mobile device's internal memory to be minimized. Furthermore, in some embodiments, the present handheld mobile device does not require the user to open the casing of the handheld mobile device to insert or eject the USB drive. Furthermore, in some embodiments, and as discussed below in greater detail, the handheld mobile device (as well as the USB drive) may be inactive unless authorization is provided (e.g., using a biometric sensor). Thus, if an inaccurate or unauthorized attempt is made to access the phone, or to reinstall or erase the handheld mobile device operating system, the handheld mobile device will not function or grant access to operable features of the device since the authorization code (e.g., biological features provided by the owner of the handheld mobile device) is stored on the USB drive itself. That is, at worst, only the data on the handheld mobile device is erased, but not the data on the USB drive. In some embodiments, the USB drive can be used to store data related to a network access, and access to the network can be granted upon successfully matching biometric data (e.g., thumbprint information) obtained using a biometric sensor (e.g., a thumbprint reader) to previously stored biometric data (e.g., through a port).

A Second Exemplary Handheld Mobile Device and Applications Processor

FIG. 3B shows a second embodiment 100B of the handheld mobile communications device including an alternate applications processor or architecture 101B. As shown in FIG. 3B, the second applications processor 101B generally comprises circuitry the same as or similar to that of the first applications processor 101A of FIG. 3A.

However, applications processor 101B has a multimedia card (MMC) or embedded MMC 131 further comprising secure digital input/output (SD/SDIO) circuitry coupled to the USB drive 135. The circuitry within the SD/SDIO eMMC/MMC 131 includes a controller for external memory (e.g., USB drive 135), and the SDIO circuitry within the SD/SDIO eMMC/MMC 131 allows the drive slot (e.g., a USB port or interface) of the handheld mobile device 100B to support an “external” device (e.g., a removable but integratable, USB drive located in the housing of the handheld mobile device 100B, and having an outer surface coplanar and/or coextensive with the handheld mobile device housing, as discussed herein). Stated differently, eMMC/MMC 131 includes a controller for the USB drive 135 and SD/SDIO circuitry to allow the controller to support the I/O functions of the USB drive 135 in a secure manner.

A Third Exemplary Handheld Mobile Device and Applications Processor

FIG. 3C shows a block diagram for a handheld mobile communication device 100C including an alternative applications processor 101C. As shown in FIG. 3C, the applications processor 101C comprises circuitry the same as or similar to that of the applications processors 101A and 101B discussed above with respect to FIGS. 3A and 3B. However, applications processor 101C of FIG. 3C comprises a separate (embedded) multimedia card 132 and SD/SDIO circuitry 133.

Specifically, applications processor 101C comprises separate eMMC/MMC 132, which can be similar to SD eMMC/MMC 110 discussed above with respect to FIG. 3A. Additionally, SD/SDIO circuitry 133 can include circuitry similar to SD/SDIO eMMC/MMC 131 discussed above with respect to FIG. 3B. For example, eMMC/MMC 132 includes a controller for the external memory (e.g., the USB drive 135), and SD/SDIO circuitry 133 allows the controller to support the I/O functions of the USB drive 135 in a secure manner.

A Fourth Exemplary Handheld Mobile Device and Applications Processor

FIG. 3D shows a block diagram for a handheld mobile communication device 100D including an alternative applications processor 101D. As shown in FIG. 3D, the applications processor 101D comprises circuitry the same as or similar to that of applications processors 101A, 101B, and 101C discussed above with respect to FIGS. 3A-3C. For example, applications processor 101D comprises NAND flash memory 115, boot ROM 105, and wireless communications circuitry 120, each of which is similar to or the same as that discussed above with respect to FIGS. 3A-3C. SD eMMC/MMC controller 110′ can be the same as or similar to SD eMMC/MMC controller 110 discussed above with respect to FIG. 3A.

In the embodiment of FIG. 3D, SD eMMC/MMC controller 110′ is configured to receive data from and write data to a removable SD MMC card 137. Applications processor 101D also comprises an internal USB drive 136, configured to allow direct connectivity between applications processor 101D and the USB drive. The internal USB drive 136 in FIG. 3D is further configured to support a USB on-the-go (OTG) function and/or port. Thus, applications processor 101D comprises multiple memory devices (e.g., a USB flash drive 136, a NAND flash drive 115, an SD MMC card 137, SDRAM 113, L2 cache 130, etc.).

A First Exemplary Handheld Mobile Device Utilizing a Biometrics Sensor

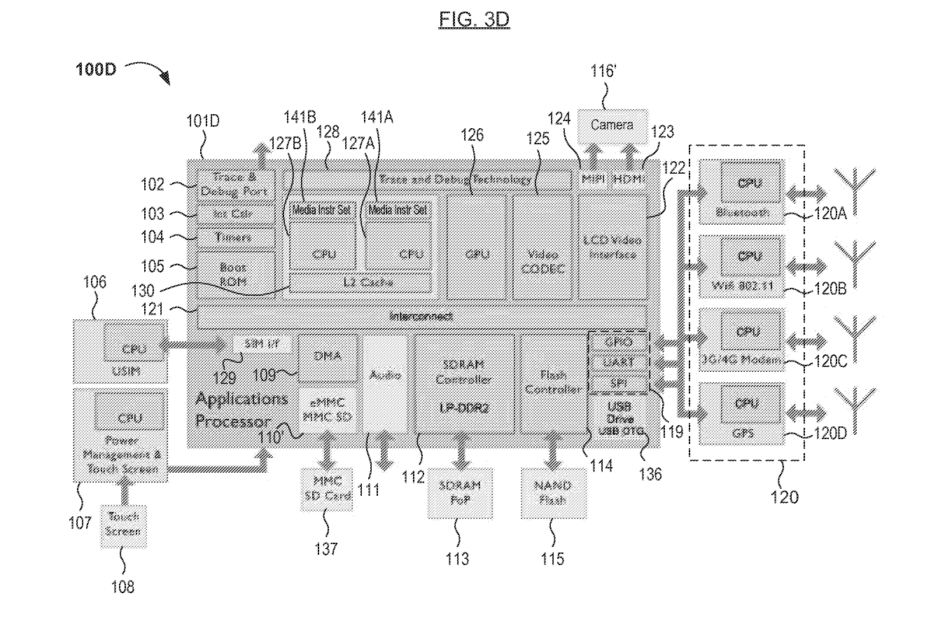

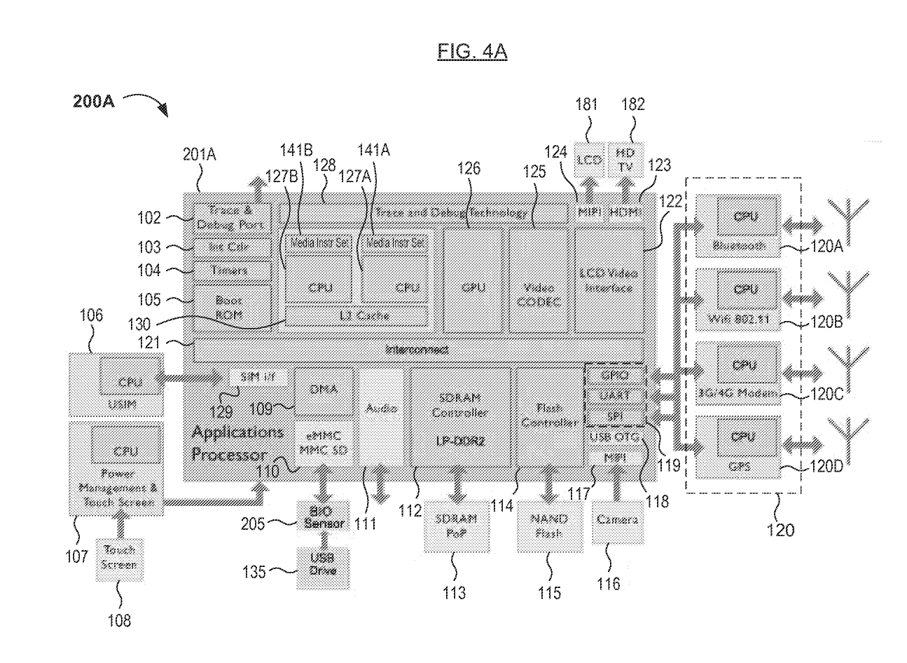

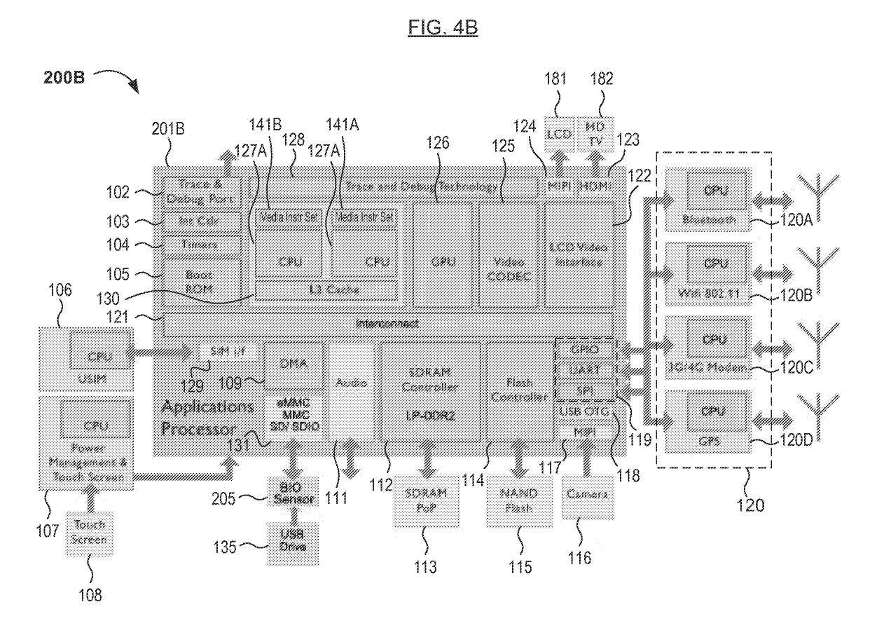

FIG. 4A shows a block diagram for a handheld mobile communication device 200A including an exemplary applications processor 201A. As shown, the applications processor 201A comprises circuitry the same as or similar to that of the applications processor 100A discussed above with respect to FIG. 3A (e.g., trace and debug port 102, interrupt controller 103, wireless communications circuitry 120, etc.). USB drive 135 can be the same as or similar to that discussed above with respect to FIG. 3A with the exception that a biosensor 205 controls authorization of access to USB drive 135.

As shown, USB drive 135 is coupled to biosensor 205 (e.g., a fingerprint scanner, a retina scanner, voice recognition circuitry and/or software, etc.). In some embodiments, the biometric sensor 205 can be used to capture a digital image (e.g., a live scan) of a user's fingerprint pattern. The live scan can be digitally processed and compared to a previously stored biometric template (e.g., a collection of features extracted from a previously stored digital image using biosensor 205) and used for matching. If the biometric features obtained during the live scan match previously stored biometric features, then the user is granted access to the USB drive 135.

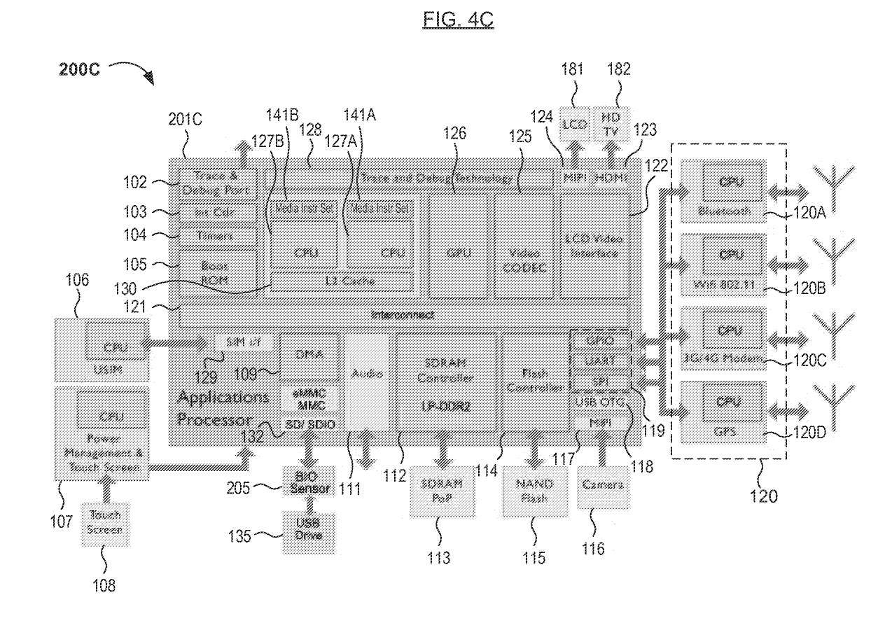

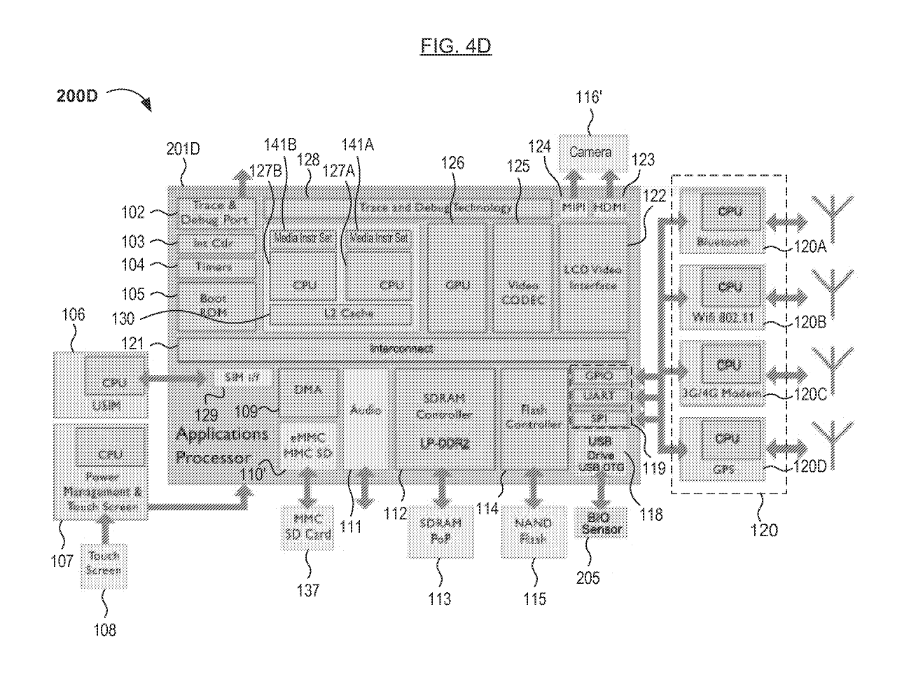

As shown, USB drive 135 communicates with biosensor 205, which in turn, communicates with SD eMMC/MMC 110. Alternatively, biosensor 205 can communicate with USB drive 135, which in turn communicates with SD eMMC/MMC 110 or replaces SD eMMC/MMC 110 (see, e.g., FIGS. 5B-5C), or biosensor 205 can communicate in parallel with both SD eMMC/MMC 110 and USB drive 135 (both of which can optionally communicate directly with each other).

In some embodiments, the USB drive 135 comprises an integrated biometric sensor 205. In some embodiments, the biosensor 205 can include a flat panel-type sensor, a micro fiber-based sensor, or a “rolling pin” style sensor, where the user sweeps a finger (e.g., a thumb, index finger, etc.) across a roller-like component. The biometric sensor 205 may then read, transfer and/or transmit the applied fingerprint information and/or data using fiber optic technology. In some embodiments, biosensor 205 utilizes photonic crystal fibers for user identification purposes. Additionally, the biosensor 205 can be configured to allow applications processor 201A to access data stored on USB drive 135 (e.g., via controller circuitry in SD eMMC/MMC 110 or in USB hard drive 135). In some embodiments, as discussed below, biosensor 205 may be configured to allow access to a network in communication with wireless communications circuitry 120.

A Second Exemplary Handheld Mobile Device Utilizing a Biometrics Sensor

FIG. 4B shows a block diagram for a mobile device 200B including an alternative applications processor 201B. As shown in FIG. 4B, the applications processor 201B comprises circuitry the same as or similar to that of the applications processor 101B discussed above with respect to FIG. 3B (e.g., trace and debug port 102, interrupt controller 103, wireless communications circuitry 120, etc.). Additionally, the circuitry within the SD/SDIO eMMC/MMC 131 can be the same as that discussed above with respect to FIG. 3B, and include a controller for external memory (e.g., USB drive 135), and SDIO circuitry within the SD/SDIO eMMC/MMC 131 to allow the drive slot (e.g., a USB port or interface) of the mobile device 200B to support an external device (e.g., a USB drive, as discussed herein). That is, eMMC/MMC 131 includes a controller for the USB drive 135 and SD/SDIO circuitry to allow the controller to support the I/O functions of the USB drive 135 in a secure manner. Furthermore, USB drive 135 can be the same as or similar to that discussed above with respect to FIGS. 3A-3D, with the exception that a biosensor 205 controls authorization of access to USB drive 135.

As shown, USB drive 135 is coupled to biosensor 205. Biosensor 205 can include a fingerprint scanner, a retina scanner, voice recognition hardware and/or software, etc., that may be the same as the embodiments shown in FIGS. 4A and 4C-4D. Biosensor 205 is configured to allow applications processor 201B access to data stored on USB drive 135 (e.g., via SD/SDIO eMMC/MMC 131). Thus, in some embodiments of the present invention using a biosensor, biometric data for authorization may be stored in a memory or MMC 131 (or SD eMMC/MMC 110 discussed above with respect to FIG. 3A, or eMMC/MMC 132 discussed above with respect to FIG. 3C). Additionally, in some embodiments, as discussed below, biosensor 205 may be configured to allow access to a network in communication with wireless communications circuitry 201.

A Third Exemplary Handheld Mobile Device Utilizing a Biometrics Sensor

FIG. 4C shows a block diagram for a handheld mobile communication device 200C including a further alternative applications processor 201C. As shown in FIG. 4C, the applications processor 201C comprises circuitry the same as or similar to that of the applications processor 101C discussed above with respect to FIG. 3C (e.g., trace and debug port 102, interrupt controller 103, wireless communications circuitry 120, etc.). USB drive 135 can be the same as or similar to that discussed above with respect to FIGS. 3A-3D, with the exception that a biosensor 205 controls authorization of access to USB drive 135.

As shown, USB drive 135 is coupled to biosensor 205. Biosensor 205 can be configured to allow applications processor 201C access to data stored on USB drive 135 via SD/SDIO circuitry 133 in combination with eMMC/MMC 132. For example, USB drive 135 can store information (e.g., network registration information) that, when authorized by biosensor 205, is transferred to SD/SDIO 133. SD/SDIO 133 then securely provides data stored on USB drive 135 to eMMC/MMC 132. Thus, eMMC/MMC 132 includes a controller for the USB drive 135, and SD/SDIO 133 allows the controller to support the I/O functions of the USB drive 135 in a secure manner. In some embodiments, as discussed below, biosensor 205 may be configured to allow access to a network in communication with wireless communications circuitry 201.

A Fourth Exemplary Handheld Mobile Device Utilizing a Biometrics Sensor

FIG. 4D shows a block diagram for a handheld mobile communication device 200D including a still further alternative applications processor 201D. As shown in FIG. 4D, the applications processor 201D comprises circuitry the same as or similar to that of the applications processor 101D discussed above with respect to FIG. 3D (e.g., trace and debug port 102, interrupt controller 103, wireless communications circuitry 120, etc.). USB drive 135 can be the same as or similar to that discussed above with respect to FIGS. 4A-4C.

As shown, applications processor 201D includes an internal USB drive 136 configured to allow direct connectivity between applications processor 201D and the USB drive 136. The internal USB drive 136 in FIG. 4D is also configured to support one or more USB OTG functions and/or ports. In the present embodiment, biosensor 205 is coupled to and receives a voltage from USB drive 136. As discussed below in greater detail, biosensor 205 may be configured to allow access to a network (e.g., Wi-Fi, GPS, etc.) that is in electrical communication with wireless communications circuitry 201.

A First Exemplary Handheld Mobile Device Utilizing a USB Drive Comprising Hardware and/or Software Capabilities

FIG. 5A shows an exemplary block diagram for a handheld mobile device 500A, including a further alternative applications processor 501A. As shown in FIG. 5A, the applications processor 500A comprises circuitry the same as or similar to that of the applications processor 201C discussed above with respect to FIG. 4C (e.g., trace and debug port 102, interrupt controller 103, wireless communications circuitry 120, etc.). Ejectable USB drive 510 can be similar to USB drive 135 discussed above with respect to FIG. 4C, and can also include hardware and/or software similar to that provided by SDIO circuitry, but USB drive 510 can be inserted into and ejected from a slot in the side or end of the mobile device (e.g., a cellular phone), and the SDIO circuitry or an SD card can be omitted. Biosensor 205 can be the same as that discussed above with respect to FIGS. 4A-4D, and can control the authorization of access to USB drive 510.

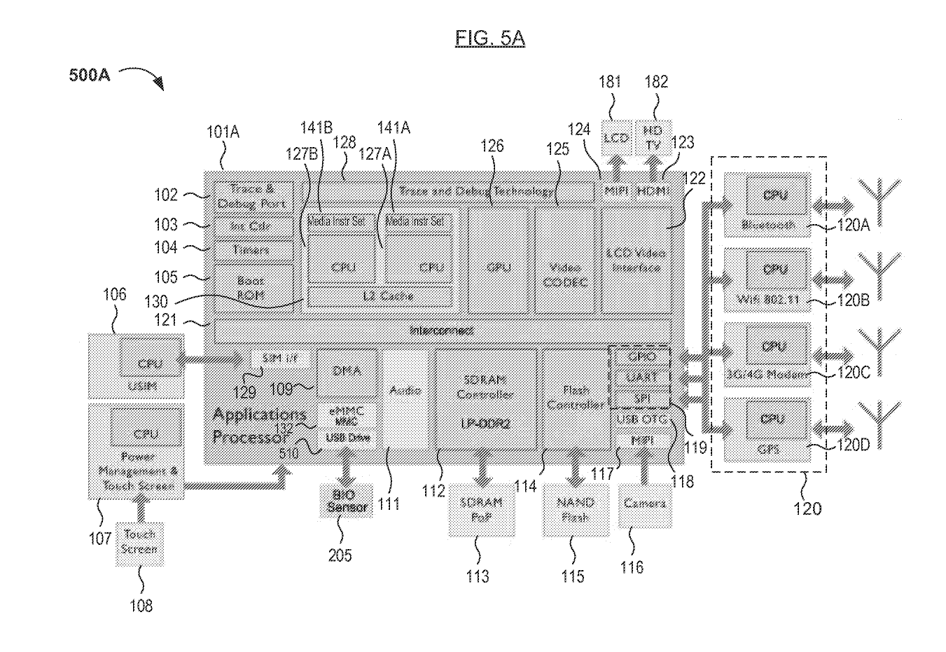

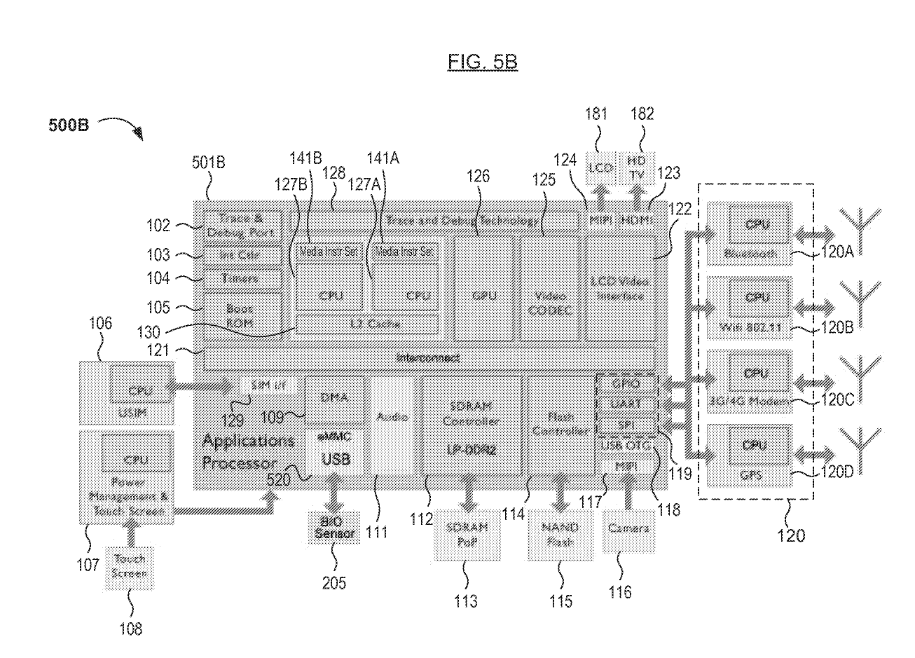

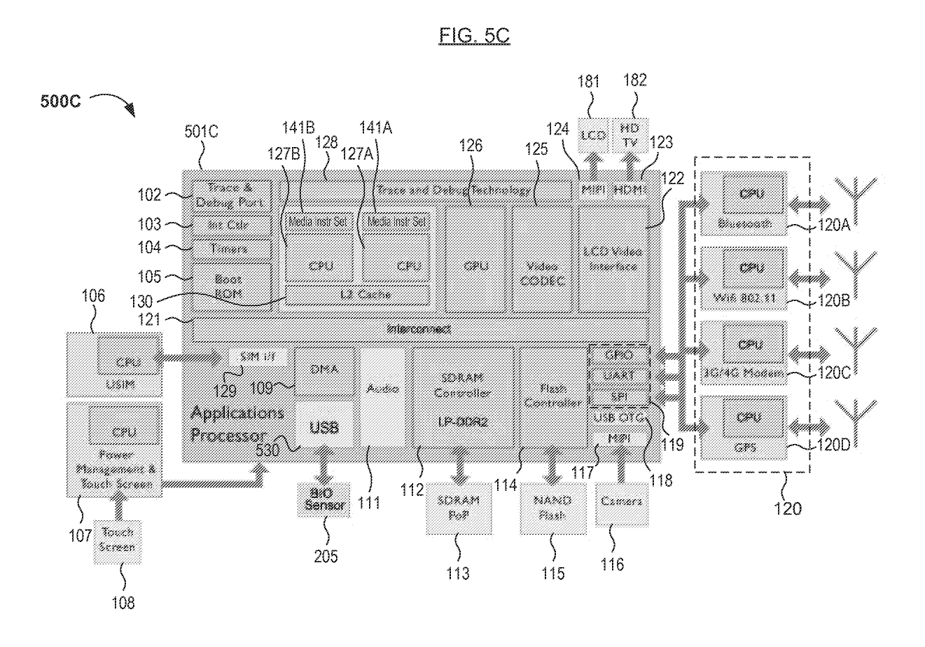

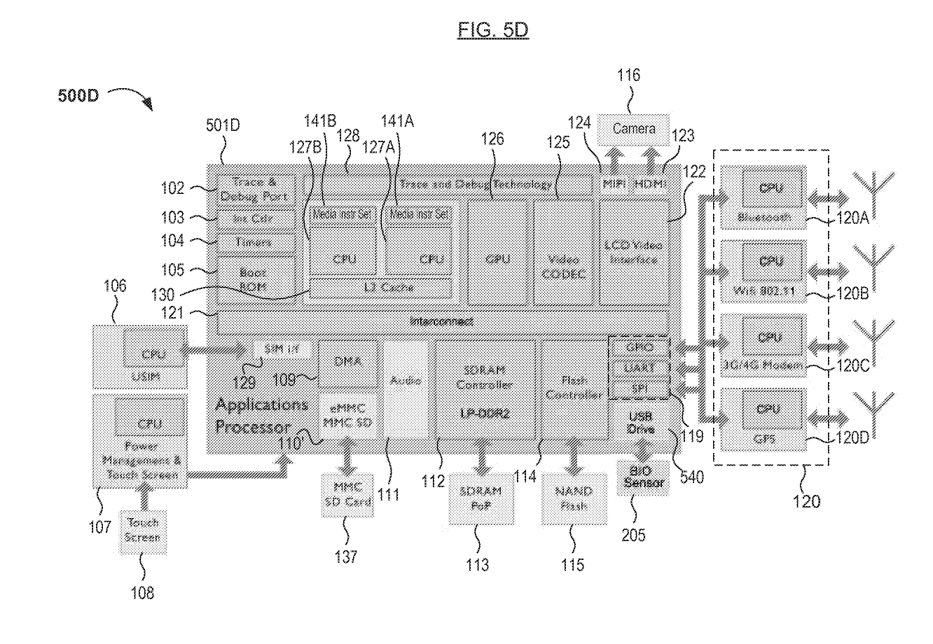

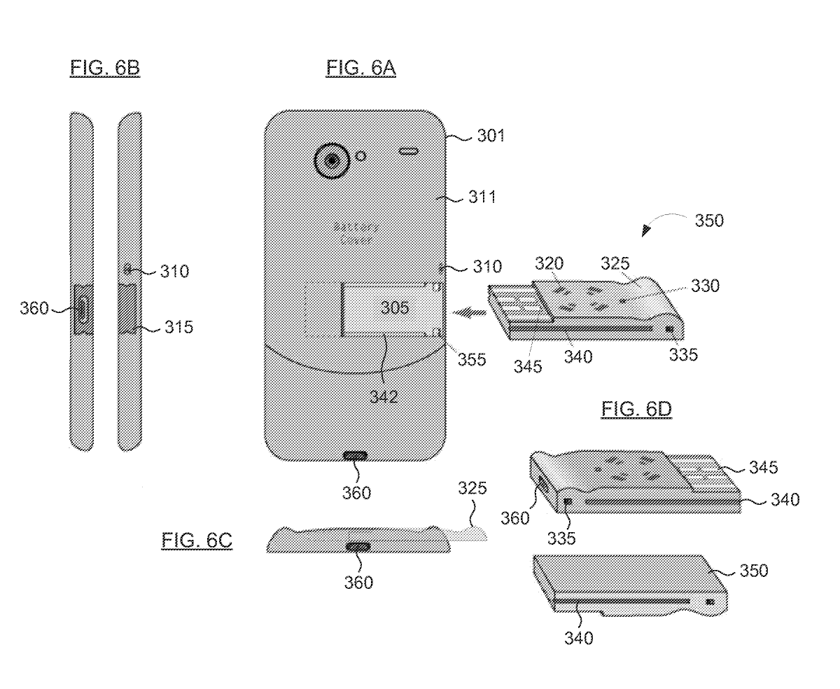

USB drive 510 can include memory having storage capabilities of about 64 gigabytes (Gb), 128 Gb, and even up to 256 Gb. The USB drive 510 may also include hardware (e.g., a wireless communications receiver [e.g., GPS, Bluetooth, Wi-Fi, TV, FM, AM, Eye-Fi, etc.], a RFID reader, a digital camera, a microphone, a data scanner, a fingerprint reader, a battery, etc.) and software configured to provide additional functionality to the handheld communication device (or other terminal). Thus, greater functionality can be provided to the handheld mobile device with the addition of USB drive 510. That is, a mobile device user is not required to upgrade hardware and/or software to increase the functions of the mobile device since such functions are provided by the USB drive 510 itself. USB drive 510 also comprises an interface such as a USB or micro USB interface (e.g., USB interface 345 discussed herein with respect to FIG. 6A), or any other interface capable of coupling to the architecture 501A in the handheld mobile device.

In some embodiments, when the USB device is removed from the interface and/or the handheld mobile device, the functionality of the mobile device (e.g., mobile communications connectivity, photo-taking abilities) may be limited when such functionality is provided by the USB drive. Thus, in some embodiments, software and/or hardware can be included elsewhere in the mobile device (e.g., in NAND flash 115) to maintain the mobile device functionality. In any embodiment, after the USB drive 510 is removed from the applications processor 501A, the USB drive 510 retains data, files, programs, etc. stored in its memory.

A Second Exemplary Handheld Mobile Device Utilizing a USB Drive Comprising Hardware and/or Software Capabilities

FIG. 5B shows a second exemplary block diagram for a handheld mobile device 500B, including a further alternative applications processor 501B. As shown in FIG. 5B, the applications processor 500B comprises circuitry the same as or similar to that of the applications processor 201B discussed above with respect to FIG. 4B (e.g., trace and debug port 102, interrupt controller 103, wireless communications circuitry 120, etc.).

As shown, applications processor 501B comprises eMMC USB 520. eMMC USB 520 can have functions the same as or similar to SD/SDIO eMMC/MMC 131 discussed above with respect to FIG. 4B. However, eMMC USB 520 can also have the form and functionality of a USB drive, such as USB drive 510 discussed above with respect to FIG. 5A, and the SD/SDIO circuitry and/or card can be omitted. Thus, USB drive 520 may comprise memory, a memory controller (not shown), peripheral hardware and/or software (e.g., a microphone, a digital camera, etc.), and an internal USB or micro USB interface (e.g., USB interface 345 discussed herein with respect to FIG. 6A), or any other interface capable of coupling to the architecture 501B in the handheld mobile device. Biosensor 205 can be the same as that discussed above with respect to FIGS. 4A-4D, and can control the authorization of access to USB drive 520.

A Third Exemplary Handheld Mobile Device Utilizing a USB Drive Comprising Hardware and/or Software Capabilities

FIG. 5C shows a third exemplary block diagram for a handheld mobile device 500C, including a further alternative applications processor 501C. As shown in FIG. 5C, the applications processor 500C comprises circuitry the same as or similar to that of the applications processor 201A discussed above with respect to FIG. 4A (e.g., trace and debug port 102, interrupt controller 103, wireless communications circuitry 120, etc.).

As shown, applications processor 501C comprises USB drive 530. USB drive 530 can be similar to USB drive 510 discussed above with respect to FIG. 5A, but it completely replaces the eMMC/MMC and SD/SDIO circuitry of FIGS. 3A-3C and 4A-4C. Thus, USB drive 530 comprises memory, a memory controller (not shown), hardware and/or software (e.g., a microphone, a digital camera, etc.), and an interface such as an internal USB or micro USB interface (e.g., USB interface 345 discussed herein with respect to FIG. 6A), or any other interface capable of coupling to the applications processor 501C in the handheld mobile device. Biosensor 205 can be the same as that discussed above with respect to FIGS. 4A-4D, and can control the authorization of access to USB drive 530.

A Fourth Exemplary Handheld Mobile Device Utilizing a USB Drive Comprising Hardware and/or Software Capabilities

FIG. 5D shows a fourth exemplary block diagram for a handheld mobile device 500D, including a further alternative applications processor 501D. As shown in FIG. 5D, the applications processor 500D comprises circuitry the same as or similar to that of the applications processor 201D discussed above with respect to FIG. 4D (e.g., trace and debug port 102, interrupt controller 103, wireless communications circuitry 120, etc.). For example, SD eMMC/MMC 110′ can be the same as that discussed above with respect to FIG. 3D. That is, SD eMMC/MMC controller 110′ can be configured to receive data from and write data to a removable SD MMC card 137.

As shown, applications processor 501D comprises USB drive 540. USB drive 540 can be similar to USB drive 510 discussed above with respect to FIG. 5A. Thus, in some embodiments, USB drive 540 comprises memory, a memory controller (not shown), peripheral hardware and/or software (e.g., a microphone, a digital camera, etc.), and an interface such as an internal USB or micro USB interface (e.g., USB interface 345 discussed herein with respect to FIG. 6A), or any other interface capable of coupling to the applications processor 501C in the handheld mobile device. Biosensor 205 can be the same as that discussed above with respect to FIGS. 4A-4D, and can control the authorization of access to USB drive 540.

An Exemplary Handheld Mobile Device and USB Drive Configuration

As discussed herein, and as shown in FIG. 6A, a USB drive (e.g., a sliding and/or micro USB drive 350) can be coupled to a handheld wireless communication device (e.g., a smartphone, tablet or pad computer, GPS device, personal digital assistant, handheld game player, camera, etc.) 301 according to the present invention. The handheld wireless communication device 301 may comprise an internal USB port or bay 305 (e.g., a standard [USB 2.0, USB 3.0], mini- or micro-USB port configured to accept a thumb drive-like device) configured to receive an integrated data storage device (e.g., USB drive slider 350) comprising an integrated universal serial bus (USB) interface 345. The handheld wireless communication device 301 may further comprise a micro USB port 360 located in the bottom surface or “edge” of the device 301 (see also FIG. 6B). FIG. 6B shows a view of the bottom surface or “edge” of the device 301 and how the USB drive 350 (i) slides into and out from the back of the device 301 and (ii) mates with the contour along the back surface 311 of the device 301.

As shown in FIG. 6A, the port 305 is located at a right central location on the back of the mobile device 301. In alternative embodiments, port 305 is located at a bottom, top, or left location on the back of the mobile device 301. For example, in the right-hand embodiment of FIG. 6C, port 305 having USB driver slider 350 therein (and release and/or ejection trigger 310 adjacent thereto) is located at a right central location on the back of the mobile device 301. In the left-hand embodiment of FIG. 6C, port 305 having USB driver slider 350 therein (with USB OTG port 360 in an external surface thereof) is at a left central location on the back of the mobile device 301. The port 305 may further comprise a digitally controlled lock pin mechanism 355 (FIG. 6A) to secure the USB drive 350 to the mobile device 301, as discussed below in greater detail.

In some embodiments, the port 305 is located within and/or under an external cover 311 of the mobile device 301. Alternatively, the port 305 is located within and/or under a battery cover of the mobile device 301. In further embodiments, the mobile device 301 comprises a USB trigger release and/or ejection button 310 (see also FIG. 6C) to eject or enable the USB drive 350 to be removed. In any embodiment, the USB drive 350 may have a casing or external surface 315 that covers the drive itself, protects the port 305, and is coplanar, continuous, coextensive, integrated and/or integratable with cover 311 (e.g., includes a ridge 325 when the casing of the mobile device 301 includes such a ridge; see FIG. 6B).

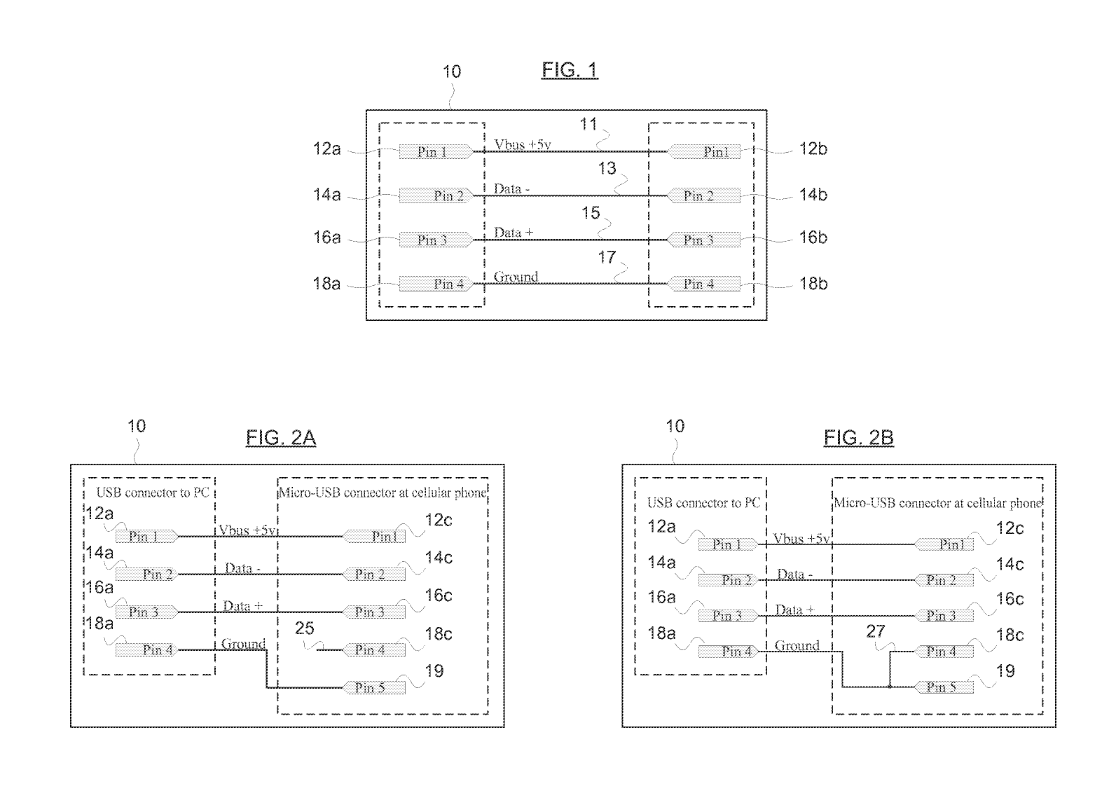

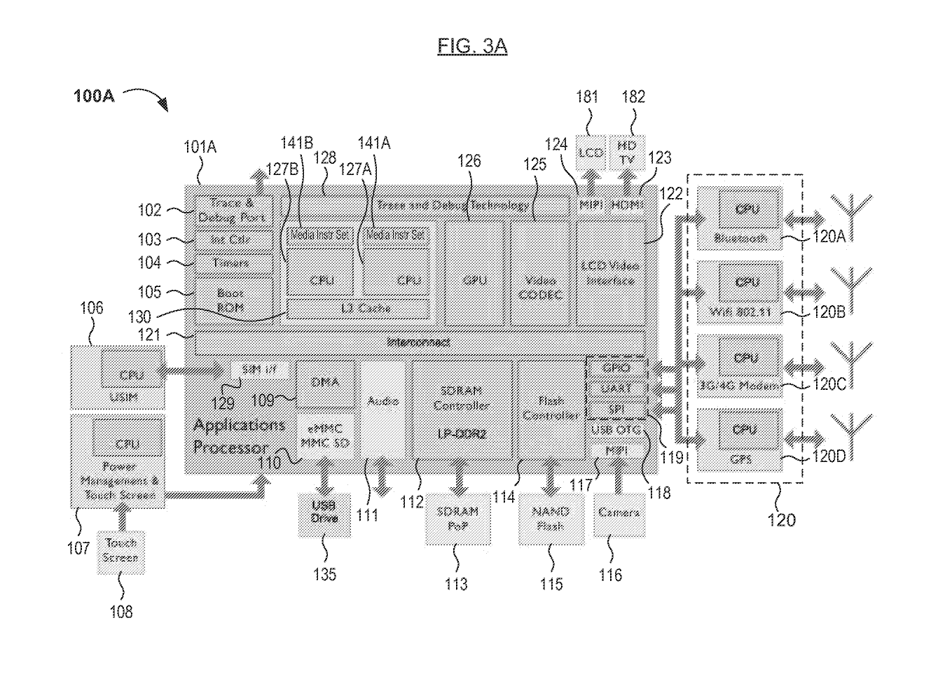

As shown in FIGS. 6A and 6D, the USB drive (or USB drive slider) 350 comprises one or more sliding channels 340 (e.g., a female sliding channel or groove) configured to detachably connect to one or more corresponding projections (e.g., a complementary male bar-like projection or rail 342) in the port 305. The USB drive 350 further comprises terminals 345 configured to electrically connect to corresponding terminals (not shown) in the port 305. For example, the terminals 345 can have a USB-type pinout (FIG. 2A, 2B or 8A) or another type of interface (e.g., a PS/2-type pinout as shown in FIG. 8B, an I²C pinout, etc.).

A connection status light 330 on a surface of the USB drive 350 can display a connection status (e.g., a secure or unsecure connection) between the USB drive slider 350 and mobile device 301. The USB drive 350 may also comprise a drive lockpin port 335 that interfaces with lockpin 355 to secure the USB drive 350 to the mobile device 301. In the present embodiment, a second lockpin port (not shown) is on a side of port 305 opposite that of lockpin port 355.

As discussed above, port 305 may further comprise a digitally controlled lockpin mechanism 355. The lockpin mechanism 355 comprises two retractable lockpins or pegs within or attached to opposite sides of the port 305. In the present embodiment, the lockpin(s) of lockpin mechanism 355 retract to enable the USB drive 350 to be completely removed from and/or inserted into port 305. Once the USB drive is fully inserted into port 305, the lockpins of lockpin mechanism 355 extend outwards and into the lockpin port(s) (e.g., lockpin port 335) of USB drive 350. In some embodiments, once the lockpins have been extended into the lockpin port(s) of the USB drive 350, the lockpins can be locked in position. For example, the lockpins can be electronically locked (e.g., using software within the handheld mobile device), or physically locked (e.g., using USB release trigger and/or ejection mechanism 310; FIG. 6C).

The USB drive 350 may also include thumb grips 320, or any other surface features and/or topography configured to facilitate or enable physical user contact with the USB drive 350 when inserting the USB drive 350 into or removing USB drive 350 from the port 305. Additionally, the USB drive 350 may have any shape or protrusion similar to ridge 325 that follows the contour or shape of the mobile device 301. The ridge 325 may be also be used to facilitate insertion and ejection of the USB drive 350. In some embodiments, the USB drive 350 further comprises an OTG charging or coupling port 360 (FIGS. 6C-6D) that can couple a voltage or power source to the mobile device 301, or connect an external device (e.g., a wireless mouse, keyboard, camera, etc.) to the mobile device 301. Generally, the bottom surface of USB drive 350 (facing towards the inside of the mobile device 301) is flat, planar, and/or smooth.

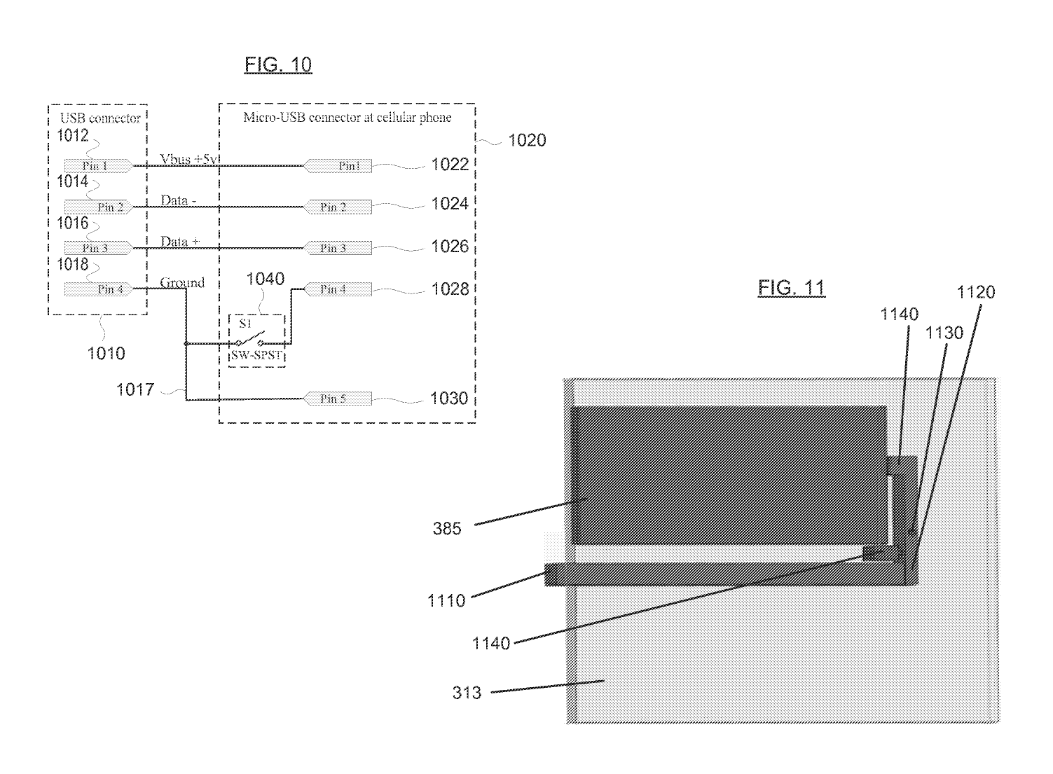

FIGS. 6E-6F show other embodiments of the present USB drive, configured with a micro-USB connector 365 at one end and standard USB connector 345 at the other end. Alternatively, the micro-USB connector 365 can be a mini-USB connector, and either the micro- or mini-USB connector can be configured as USB-A or USB-B, or it can be switchable between USB-A and USB-B (see, e.g., FIGS. 10-11 and the discussion thereof below). The micro-USB connector 365 is retractable. For example, a slidable ejector/retraction button 315 can extend the micro-USB connector 365 when in a first position (e.g., as shown in FIG. 6E) and retract the micro-USB connector 365 when in a second position. The standard USB connector 345 can communicate with the mobile device 301 through standard female USB port 305 (FIG. 6A) when the mobile device 301 is configured as a host (as described herein). When not in use with the mobile device 301, the standard USB connector 345 enables the hard drive 350a-b to communicate with a computer or other host device equipped with a standard female USB connection. In various embodiments, the ejector/retraction button 315 is a sliding button that is flush with or under the contour line of the mobile device 301. Alternatively, the ejector/retraction button 315 can be a press- or push-button type activator device. The ejector/retraction button 315 can also act or function as a switch or trigger between master and slave states (e.g., host or peripheral device). Alternatively, the ejector/retraction button 315 and/or hard drive 350a-b can be programmed to automatically switch the hard drive and/or mobile device 301 between master and slave states, depending on whether the micro-USB connector 365 is retracted or not. The design contour shown in FIG. 6E can be reversed, as well as the channel 340 and lock pin holes 335. Also, as shown in FIG. 6F, the side of hard drive 350 with the standard USB connector 345 can be approximately flush with the upper surface of the hard drive, and the side with the micro-USB connector 365 can be slightly cut out so it can slide into the mobile device 301, fitting snugly under the cover. In one variation, a plastic cover can be placed or fitted over the standard USB connector 345 when the micro-USB connector 365 is in use in mobile device 301.

FIG. 8A illustrates an exemplary standard USB pinout 400 for the present handheld mobile device. As shown, FIG. 8A shows a housing 401 for a USB female interface. The pins of the interface may electrically connect to corresponding terminals (e.g., terminals 345 in FIG. 6A) of the present USB device. As shown, a first pin 401 provides a voltage (e.g., +5V), a second pin 415 (e.g., a first data pin) sends or receives true or complementary data (e.g., one of a pair of complementary and/or differential signals), a third pin 420 (e.g., a second data pin) sends or receives the other of the true, complementary, or differential signals, and a fourth pin 425 (e.g., a GND pin) provides a ground connection. Wires coupled to pins 410-425 within the housing interface 401 may be color coded. For example, in some embodiments, a first wire coupled to pin 410 may be red, a second wire coupled to pin 415 may be white, a third wire coupled to pin 420 may be green, and a fourth wire coupled to pin 425 is black. In any embodiment, the present USB pinout diagram can be used by the present USB drive to transfer data to and/or from the handheld mobile communication device (or other terminal).

In some embodiments, other interfaces can be used, such as the PS/2 pinout illustrated in FIG. 8B. The PS/2 pinout of FIG. 8B can couple a hard drive to a terminal or handheld mobile device according to the present invention. More specifically, a first pin in a PS/2 configuration may be a data pin, another pin can provide a ground connection, a third pin can provide a voltage (e.g., a +5V common-collector voltage), and a fourth pin can provide a clock (e.g., CLK) signal. In such a pinout configuration, one or more additional pins (e.g., pin numbers 2 and 6 in FIG. 8B) may not be used. Alternatively, any unused pin may be used for other functions (e.g., differential data, a control/enable signal, etc.). Thus, the present hard drive can have a USB interface, a PS/2 interface, a three-pin or three-wire interface (e.g., I²C interface), or any other interface configured to transfer data to a terminal or handheld mobile device according to the present invention.

An Exemplary Handheld Mobile Device and USB Drive Comprising a Biometric Sensor

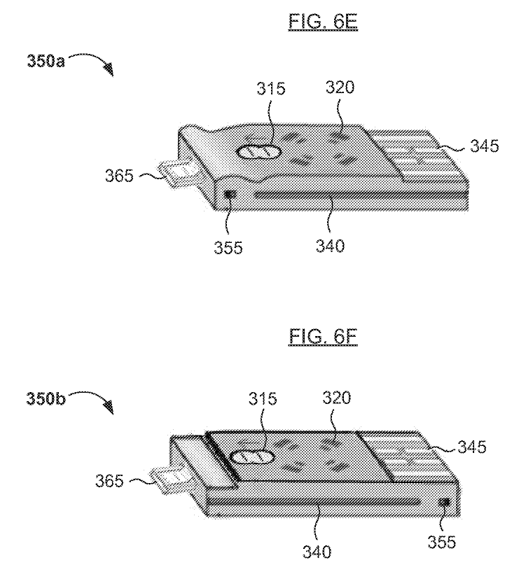

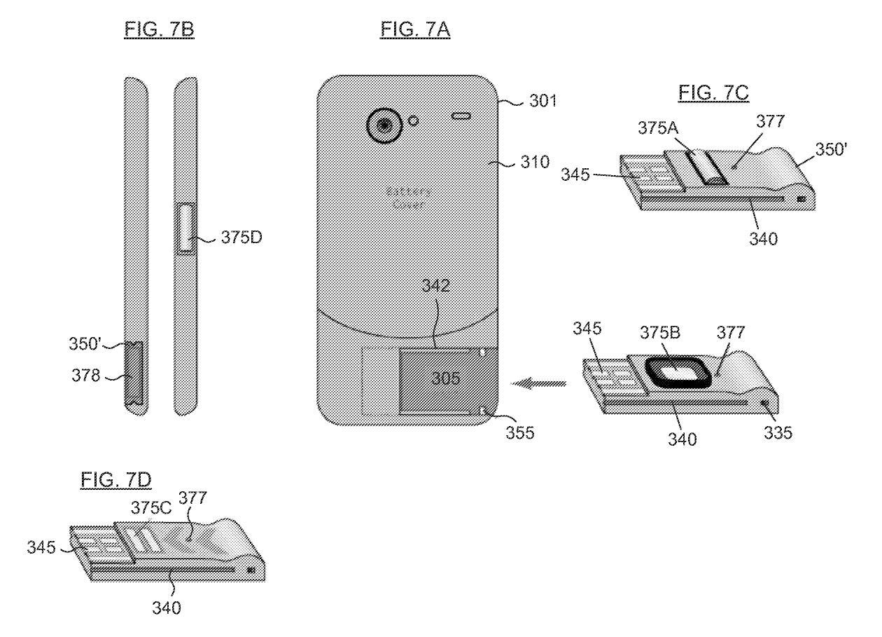

FIG. 7A shows an alternative embodiment of a mobile device 301′ and USB drive according to the present invention. Port 305′ can be the same as or similar to that discussed above with respect to FIG. 6A, and can have any of the pinouts and/or interfaces (e.g., as shown in FIGS. 8A-8B) as port 305 in FIG. 6A. In the embodiment of FIG. 7A, the port 305′ is located in a lower right portion on the back of the mobile device 301. The mobile device 301′ also includes at least one biometrically controlled lockpin or locking mechanism 355. The lockpin 355 can be locked and unlocked using a biometric sensor (e.g., any one of biometric sensors 375A, 375B 375C, or 375D shown in FIGS. 7A-7D, as discussed herein).

As shown, the USB drive 350′ may comprise a biometric sensor (e.g., a thumbprint or fingerprint scanner 375A, a “rolling pin” fingerprint or thumbprint scanner 375B or 375C as shown in FIGS. 7B-7C, or a swipe fingerprint or thumbprint sensor 375D as shown in FIG. 7D), a retina scanner (not shown), voice recognition hardware and/or software (not shown), etc. In some embodiments, the biometric sensor (e.g., 375A-375D) includes a microphone and voice activation and/or recognition technology. In any embodiment, the mobile device 301 may comprise biometric sensor software (e.g., fingerprint or voice recognition software). Alternatively, the biometric sensor software may be stored on the USB drive 350′. Any one of the biometric sensors 375A-375D can allow access to the data stored on the USB drive 350′, allow access to a wireless network, etc.

Additionally, the biometric sensor (e.g., any one of biometric sensors 375A-375D) may be mounted on a surface of the USB drive (e.g., a rear surface or a surface opposite a touch screen, a side surface, etc.) 350′. Alternatively, the biometric sensor may be coplanar and continuous with a surface of the USB drive 350′. Furthermore, as shown in the left-hand side view of FIG. 7B, the USB drive 350′ may further include a side ejection button or mechanism 378.

As discussed above, mobile device 301′ includes a biometrically controlled lockpin 355. The lockpin 355 can be used to lock the USB drive 350′ to the mobile device 301′. For example, a USB drive 350′ can be inserted into the port 305 of the mobile device 301′. After the biometric sensor (e.g., any one of biometric sensors 375A-375D) enables access to the USB drive (e.g., by matching a live data scan with previously stored biometric features) 350′, the USB drive 350′ can be automatically locked or latched to the mobile device using a lockpin (or lockpins) 355. That is, the lockpins can be locked and unlocked (or an unlock mechanism and/or option can be enabled or authorized) using biosensor 305. In alternative embodiments, the locking mechanism (e.g., lockpin 355 or release/ejection trigger 310 discussed above with respect to FIG. 6A) can be generated (e.g., a password or code can be entered into the mobile device using software and hardware to extend lockpin 355 into the lockpin port(s) of the USB drive 350 or 350′).

To remove the USB drive 350′, the biometric sensor can be used to match a fingerprint or other biometric reading and unlock lockpin 355 of the mobile device (e.g., retract lockpin 355 from port 335). In some embodiments, unlocking the lockpin 355 of the mobile device 301 also ejects the USB drive 350′ (e.g., from a side of the mobile device 301′). In any embodiment, the USB drive 350′ and data stored thereon can be secured to the mobile device 301 (e.g., utilizing lockpin 355) and provide an additional level of security.

Further Exemplary Handheld Mobile Devices and USB Drives

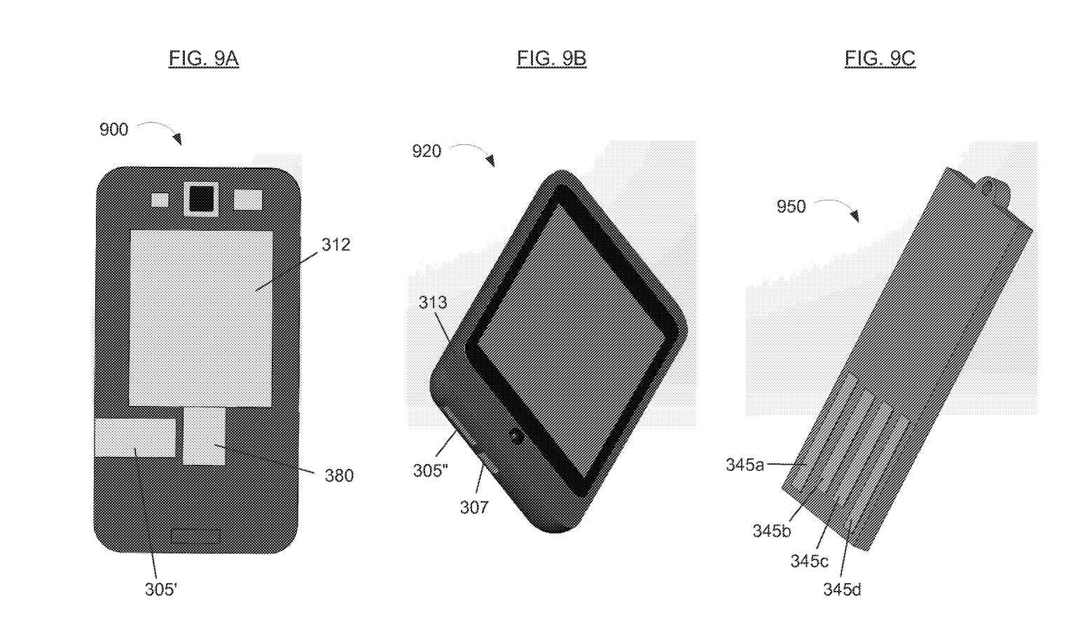

FIG. 9A shows the back of an exemplary handheld mobile device 900 (e.g., a smart phone such as the Samsung GALAXY S, GALAXY SIII, etc.). Various ports and/or storage locations are shown, such as battery storage area 312, sim card storage area/port 380, and mini-USB port/location 305″. The back cover of the mobile device 900 over the mini-USB port 305″ has been removed for clarity. The exemplary handheld mobile device 900 operates with a USB drive 350 or a USB drive 950 (see FIG. 9C) in the same or substantially the same manner as mobile devices 301 and 301′ in FIGS. 6A and 7A.

FIG. 9B shows the front face and bottom edge of another exemplary handheld mobile device 920 (e.g., a smart phone such as the HTC HERO, WILDFIRE, WILDFIRE S, DROID DNA, EVO, ONE, etc.). Mobile device 920 includes mini-USB port 305′″ and micro-USB port 307 along the bottom edge. The exemplary handheld mobile device 920 may operate with a conventional USB drive 950 (FIG. 9C) that is removably inserted into mini-USB port 305″.

FIG. 9C shows a USB drive 950, such as the TUFF-N-TINY USB flash drive (available from Verbatim Americas, LLC, Charlotte, N.C.). The USB drive 950 is shown having a four-pin interface 345a-345d, but in some embodiments, 1 or 2 additional pins may be provided. The USB drive 950 can be inserted into and ejected from port 305″ in the mobile device 900 of FIG. 9A or port 305′″ in the mobile device 920 of FIG. 9B.

An Exemplary Switchable Host/Peripheral USB Interface

If one has a USB controller chip in the handheld mobile device that is compatible with a USB specification (e.g., the mini-B USB, micro-B USB, or USB OTG specification), and Pin4 of the mini- or micro-USB connector (e.g., pin 18c of FIGS. 2A-2B) is tied to ground, either electrically or mechanically, or to the ground wire 17 in the cable, the cellular phone is now capable of being a host. In this case, anything tied to the USB connector that normally goes to a host such as a computer is a peripheral, and will work properly with the mobile device as long as it has the appropriate drivers and software. For example, if the left-hand USB connector in FIG. 2B is connected to a peripheral device, such as a USB memory stick or a mouse, instead of a PC, the mouse or USB memory stick will perform as if connected to a PC, as long as the cellular phone has appropriate driver software. Thus, the USB memory stick can be read or written to by the cellular phone.

For example, a conventional smart phone having Pin4 (e.g., pin 18c) tied to Pin5 (e.g., pin 19) of the USB connector, and connected to a peripheral device such as a mouse or a USB flash drive through the USB connector that normally goes to the computer, the mouse or USB flash drive will work properly. Thus, to use mobile device 920 in a conventional manner (e.g., with a PC) and also allow it to use a USB port (such as port 305″ in FIG. 9A or port 305′″ in FIG. 9B) with a USB drive (e.g., USB drive 950 in FIG. 9C), one may incorporate into the mobile device a standard USB connector (see FIGS. 1 and 2A) as is used in PCs for USB devices. In such a case, the USB interface in the mobile device is configured as a peripheral device. However, to use the mobile device as a host device, thus allowing it to work with a USB memory stick or similar USB device, there should be a mechanism for grounding Pin4 of the micro- or mini-USB connector. When it is desired to use a USB flash drive or other similar USB device, the mobile device (e.g., cellular phone or smart phone) must be configured as a host device.

FIG. 10 shows a schematic of the mini- or micro-USB interface 1000 including a switch 1040 within the micro-USB interface 1020 in the mobile device. When the USB flash drive (e.g., USB drive 950 of FIG. 9C) or other USB-based device is inserted into the USB port or slot, switch S1 1040 is activated, placing the mobile device in the host mode (i.e., configuring the mobile device as a host). This mode allows the mobile device to read the USB flash drive and to write data or other information to the USB flash drive. The switch 1040 can be a manual switch located on the body of the handheld mobile device, or it can be a software switch controlled by software in the handheld mobile device. Alternatively, in one embodiment, the switch 1040 is a mechanical switch that senses the insertion of the USB memory stick or other USB device and causes Pin4 1028 and Pin5 1030 of the micro- or mini-USB connector 1020 to be connected together, thus causing the mobile device to go into the host mode. When the USB device is removed, the switch 1040 opens the connections between Pin4 1028 and Pin5 1030, and returns the mobile device to the peripheral mode, thus allowing for communications with a host device (e.g., a computer or PC). Any USB interface (e.g., mini-USB, micro-USB, USB OTG, etc.) can be configured in this manner to switch from a host when the USB drive is inserted to a peripheral when the USB drive is not inserted.

FIG. 11 shows a switch and ejector mechanism 1100. In the implementation shown in FIG. 11, the USB flash drive 950 slides into a port (such as port 305′″ in FIG. 9B) in the side or bottom of the mobile device. The port has the necessary connections (e.g., pins) for a conventional USB connector (see, e.g., FIGS. 2A-2B). The ejector mechanism comprises a set of two metal or plastic pieces (e.g., push rod 1110 and lever or arm 1120) that push against each other. Lever/arm 1120 pivots around a screw, pivot or other similar post 1130. As the USB drive 950 is inserted, the ejector button 1115 will be pushed out slightly from the side of the mobile device, and the switch 1040 will be activated. When the USB flash drive 950 is fully inserted, the switch 1040 will cause Pin4 and Pin5 of the USB connector (not shown in FIG. 11) to be connected, thus putting the mobile device in the host mode and allowing it to read and write to the USB flash drive 950 (or other compatible USB device). When the user desires to eject the flash drive 950 and return the mobile device to the peripheral mode, the user simply pushes on the ejector button 1115, which will cause the lever/arm 1120 to rotate around pivot point 1130 and push the USB flash drive 950 out of the port far enough to be pulled out the rest of the way with the user's fingers. When the ejector button 115 is partially or fully within the body of the mobile device, the switch 1040 will be deactivated, thus allowing Pin4 to float, which is the signal to an external device (e.g., a PC) that the mobile device is now a peripheral device. The switch and ejector mechanism 1100 of FIG. 11 can be incorporated into the mobile device 900 in FIG. 9A into port 305′, with the ejector button extending from the surface of the mobile device 900 in the area adjacent to port 305′, similar to release/ejection trigger 310 in FIG. 6A.

An Exemplary Method of Accessing a Wireless Network

The present invention also provides a method of accessing a remote network or server using the present USB drive. In some embodiments, the present invention also allows a user to access remote storage, or cloud data storage (in which data is stored in virtualized pools of data storage units). In some cases, the method may further comprise transferring registration information to a control system in communication with the communications network, and after receiving authorization from the control system, accessing a wireless communications network. In one embodiment, the registration information comprises a username and password.

For example, data stored on the present USB drive (e.g., USB drive 350 discussed above with respect to FIGS. 6A and 6B) can include network registration information (e.g., a username and associated password). A biometric sensor (e.g., any one of biometric sensors 375A-375D discussed above with respect to FIG. 6B) coupled to the USB drive 350 can provide a security feature, wherein when the biometric sensor receives a live scan matching a biological identifier (or other data) previously stored on the USB drive, the biometric sensor allows access to and/or send the registration material stored on the USB drive to the network. If the biometric sensor does not receive a live scan matching the previously stored biological identifier or data, the biometric sensor does not grant or authorize access to the data stored on the USB drive or allow access to the network.

In one embodiment, once the connection between the USB and mobile device connection is established (e.g., the biometric sensor receives a live scan matching previously stored biometric features), the registration information stored on the USB drive is accessed and transferred to a control system in communication with the communications network. As discussed above, the registration information can include a username and password associated with the network or cloud storage system. After receiving authorization from the control system, the network or cloud storage system can be accessed.

In some other or further embodiments, the USB drive is coupled to a terminal (e.g., a personal computer, a laptop, a network computer, etc.) instead of a handheld mobile device. The terminal can be used to access the network in the same method discussed above, although utilizing a terminal instead of a mobile device. Once a connection between the USB drive and the network or cloud storage is established (e.g., license and software authorization information has been provided from the USB drive to the network), the network is accessed and the user can proceed.

Once the network connection is established and the session is activated, the USB drive can be used to store personal files (e.g., user name and password, picture files, contact information and/or lists, music files, documents, etc.). Software programs used to access and manipulate the personal files may be stored in a cloud storage system in communication with the network and/or on the terminal itself (e.g., once authorization has been granted by a biosensor). That is, no user data or personal files are stored on the terminal, with the exception of temporary data files (e.g., backup data) stored in memory (e.g., cache RAM, DRAM, etc.). Once the user disconnects the USB drive from the terminal, the temporary files are deleted or erased from terminal memory, and all saved personal files are securely stored on the USB drive. Once the files are securely stored, the USB drive can be safely removed or ejected from the terminal. Thus, by utilizing the present USB drive, access to a remote network or cloud storage system can be accessed from any handheld mobile communications device comprising a data storage port (e.g., a female USB port) compatible with the present USB drive. More specifically, the present invention allows a user's personal information stored on a USB drive to be securely transferred among and/or accessed by a variety of wireless and/or communications devices (including computers, laptops, tablets, etc.). Such capabilities allow a user greater opportunities to connect to a network or cloud storage system without concerns about loss of highly sensitive and/or personal information. Stated differently, when a user wants to connect electronically to remote storage units (e.g., a cloud storage system) using a handheld mobile device, if the battery of the mobile device is depleted, the user can simply remove the USB drive and connect it to another mobile device having sufficient battery power. The USB drive can then enable the mobile device to act as a “terminal” configured to allow or deny access to a network or cloud storage (e.g., by utilizing a biometric sensor).

### CONCLUSIONS

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A handheld communication device, comprising:
a housing;
a first central processing unit (CPU) within the housing;
a first memory controller within the housing and coupled to the first CPU; and
a universal serial bus (USB) hard drive configured to electrically communicate with the first memory controller, the USB hard drive having an outer surface or casing that is coplanar, coextensive, continuous, integrated and/or integratable with the housing.

2. The handheld communication device of claim 1, further comprising a locking mechanism within the housing, configured to removably secure the USB hard drive to the wireless communication device.

3. The handheld communication device of claim 1, further comprising secure digital input output (SDIO) circuitry configured to communicate with the first memory controller and/or the USB hard drive.

4. The handheld communication device of claim 3, further comprising a biometric sensor in communication with the SDIO circuitry and the USB hard drive.

5. The handheld communication device of claim 4, wherein the biometric sensor establishes or authorizes electronic communication between the first memory controller and USB hard drive when biometric data obtained with the biometric sensor matches data stored in the USB hard drive.

6. The handheld communication device of claim 1, further comprising a multimedia card, wherein the first memory controller is on the multimedia card.

7. The handheld communication device of claim 6, wherein the multimedia card further comprises secure digital input output (SDIO) circuitry.

8. The handheld communication device of claim 6, wherein the multimedia card is embedded.

9. The handheld communication device of claim 1, further comprising interconnect circuitry configured to provide data from circuitry in or external to the handheld communication device to the first CPU.

10. The handheld communication device of claim 9, further comprising USB on-the-go (OTG) circuitry and/or a USB OTG port in communication with the interconnect circuitry.

11. A universal serial bus (USB) device, comprising:
a USB interface;
a hard drive configured to send and/or receive data and otherwise communicate through the USB interface; and
a biometric sensor, wherein the biometric sensor establishes or authorizes electronic communication between the hard drive and the USB interface when biometric data obtained with the biometric sensor matches data stored in the hard drive.

12. The USB device of claim 11, wherein the stored biometric data are stored on the hard drive.

13. The USB device of claim 11, further comprising an external surface having sliding channels, and the interface comprises electrically conductive terminals.

14. The USB device of claim 11, further comprising an outer casing, wherein the biometric sensor is mounted on or integrated in the outer casing.

15. The USB device of claim 11, wherein the biometric sensor comprises a swipe-type or roller-pin type thumbprint or fingerprint reader and/or sensor.

16. A wireless communications system, comprising:
a handheld communication device; and
the USB device of claim 11, wherein the USB device is electrically connected to the handheld communication device and stores data configured to allow the handheld communication device to access the wireless communication system.

17. The wireless communications system of claim 16, wherein the data stored on the USB device comprises a network user name and password.

18. A method of storing and/or accessing information stored on a handheld communication device, comprising:
providing biometric feature information from a biometric sensor in communication with the handheld communication device;
comparing the biometric features with biometric data stored in a hard drive in the handheld communication device; and
authorizing access to data stored in the hard drive after receiving authorization from the biometric sensor, the authorization provided when the biometric feature information matches or corresponds to the biometric data.

19. The method of claim 18, wherein the hard drive is a USB drive.

20. The method of claim 18, wherein the biometric sensor comprises a swipe-type or roller-pin type thumbprint or fingerprint reader and/or sensor.
